(19) United States
(12) Patent Application Publication
(10) Pub. No.: US 2009/0307647 A1
(43) Pub. Date: Dec. 10, 2009

(54) LAYOUT DESIGN METHOD AND COMPUTER-READABLE MEDIUM

(75) Inventors: Hideaki Murakami, Saitama-shi (JP); Mikio Nakano, Kawasaki-shi (JP)

Correspondence Address: KNOBBE MARTENS OLSON & BEAR LLP, 2040 MAIN STREET, FOURTEENTH FLOOR, IRVINE, CA, 92614, US

(73) Assignee: Kabushiki Kaisha Toshiba, Tokyo (JP)

(21) Appl. No.: 12/482,348

(22) Filed: Jun. 10, 2009

(30) Foreign Application Priority Data
Jun. 10, 2008 (JP) 2008-151827

(51) Int. Cl. G06F 17/50

(52) U.S. Cl. 716/9; 716/14

(57) ABSTRACT

A layout design method includes extracting a plurality of pairs of complementary signals from signal lines connected between a plurality of circuit blocks, for every signal lines connected between the same circuit blocks, and routing the pairs by twisting each pair.

### CROSS-REFERENCE TO RELATED APPLICATIONS

This application is based upon and claims the benefit of priority from prior Japanese Patent Application No. 2008-151827, filed Jun. 10, 2008, the entire contents of which are incorporated herein by reference.

### BACKGROUND OF THE INVENTION

1. Field of the Invention

The present invention relates to a layout design method and a computer-readable medium recording a program for executing the method, e.g., a layout design method for a semiconductor integrated circuit having twisted interconnections.

2. Description of the Related Art

In a semiconductor integrated circuit including a plurality of circuit blocks on the same substrate, a plurality of signal lines for connecting the circuit blocks are formed. If these signal lines run parallel over a long distance, the coupling capacitance between the signal lines increases. If the coupling capacitance between the signal lines increases, coupling from an adjacent signal line operating at the same frequency decreases the signal change rate. For example, when a first signal line transmits a signal that goes low, the speed of the signal transmitted by the first signal line extremely decreases if a second signal line adjacent to the first signal line goes high. Accordingly, an operation error occurs if the operating frequency is made higher than the signal change rate. On the other hand, the operating frequency decreases if it is matched with the signal change rate.

As a method of reducing the coupling capacitance between signal lines, it is possible to, e.g., (1) shield the signal lines by power lines, or (2) well separate the signal lines. Although these methods achieve satisfactory effects as countermeasures for reducing the coupling capacitance, the methods increase the area as a penalty. This increase in area is unacceptable because it becomes more and more necessary to increase the degree of integration of a semiconductor integrated circuit in the future.

As a relevant technique of this kind, a technique of reducing the coupling noise produced via the line capacitance between adjacent signal lines in a transmission circuit has been disclosed (Jpn. Pat. Appln. KOKAI Publication No. 2001-167572).

### BRIEF SUMMARY OF THE INVENTION

According to an aspect of the present invention, there is provided a layout design method comprising: extracting a plurality of pairs of complementary signals from signal lines connected between a plurality of circuit blocks, for every signal lines connected between the same circuit blocks; and routing the pairs by twisting each pair.

According to an aspect of the present invention, there is provided a layout design method comprising: extracting a plurality of pairs of complementary signals from signal lines connected between a plurality of circuit blocks; and routing the pairs by twisting each pair.

According to an aspect of the present invention, there is provided a computer-readable medium having stored thereon a program which is executable by a computer, the program controlling the computer to execute functions of: extracting a plurality of pairs of complementary signals from signal lines connected between a plurality of circuit blocks, for every signal lines connected between the same circuit blocks; and routing the pairs by twisting each pair.

### BRIEF DESCRIPTION OF THE SEVERAL VIEWS OF THE DRAWING

FIG. 1 is a view showing the layout of the major components of a semiconductor integrated circuit according to the first embodiment of the present invention;

FIG. 2 is a view specifically showing six signal lines A to F shown in FIG. 1;

FIG. 3 is a view showing the layout of the major components of another example of the semiconductor integrated circuit;

FIG. 4 is a flowchart showing a method of designing the layout of the semiconductor integrated circuit according to the first embodiment;

FIG. 5 is a block diagram showing the arrangement of a design apparatus 10 for designing the layout of the semiconductor integrated circuit according to the first embodiment;

FIG. 6 is a view for explaining a complementary signal extraction process in step S101;

FIG. 7 is a view for explaining a grouping process in step S102;

FIG. 8 is a view for explaining the grouping process following FIG. 7;

FIG. 9 is a view for explaining a pin setting process in step S104;

FIG. 10 is a view for explaining a first global routing process in step S105;

FIG. 11 is a view for explaining a regrouping process in step S106;

FIG. 12 is a view for explaining a second global routing process in step S107;

FIG. 13 is a view for explaining an example of a final routing process in step S108;

FIG. 14 is a view for explaining another example of the final routing process in step S108;

FIG. 15 is a view showing the layout of the major components of a semiconductor integrated circuit according to the second embodiment of the present invention;

FIG. 16 is a flowchart showing a method of designing the layout of the semiconductor integrated circuit according to the second embodiment;

FIG. 17 is a block diagram showing the arrangement of a design apparatus 10 for designing the layout of the semiconductor integrated circuit according to the second embodiment;

FIG. 18 is a flowchart showing a method of designing the layout of a semiconductor integrated circuit according to the third embodiment of the present invention;

FIG. 19 is a view showing the arrangement of a pin P according to the fourth embodiment of the present invention;

FIG. 20 is a view for explaining the number of pins P that are actually placed; and

FIGS. 21A and 21B are views showing the connections between the pins P and signals.

### DETAILED DESCRIPTION OF THE INVENTION

The embodiments of the present invention will be described hereinafter with reference to the accompanying drawings. In the description which follows, the same or functionally equivalent elements are denoted by the same reference numerals, to thereby simplify the description.

### First Embodiment

This embodiment is directed to the twisted structure of signal lines used in a system-on-a-chip (SoC). This embodiment is also directed to layout design of signal lines having the twisted structure. Note that the SoC is a semiconductor integrated circuit including a plurality of circuit blocks on the same substrate. First, the principle of the twisted structure of this embodiment will be explained below.

### [1. Principle of Twisted Structure]

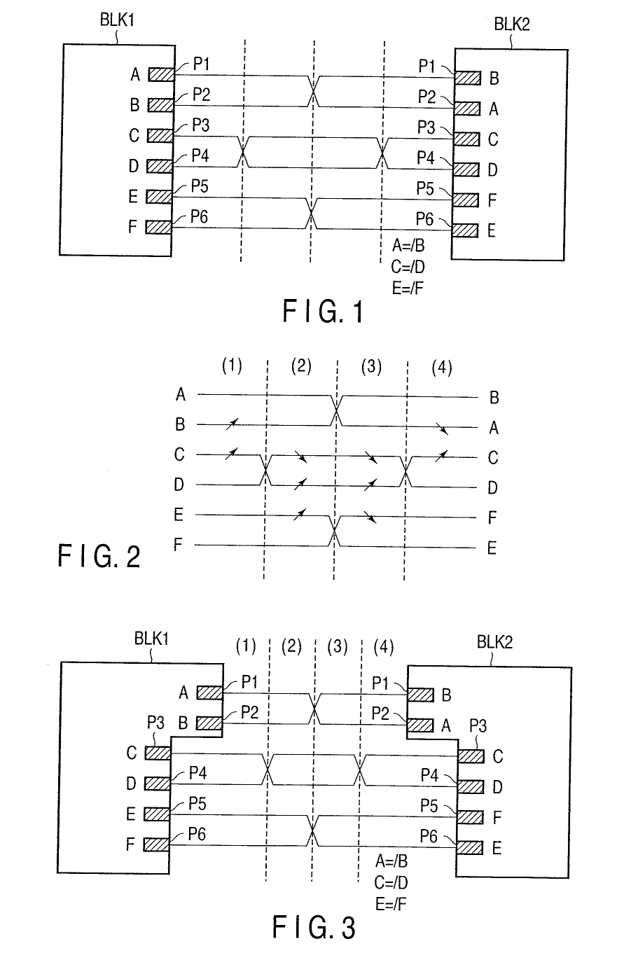

FIG. 1 is a view showing the layout of the major components of a semiconductor integrated circuit including signal lines having the twisted structure according to the first embodiment of the present invention. The semiconductor integrated circuit includes two blocks (circuit blocks) BLK1 and BLK2. Each block BLK includes circuits for performing predetermined functions, e.g., various logic circuits, arithmetic circuits, or memories.

Blocks BLK1 and BLK2 are connected by six signal lines A to F. Assuming that signal lines A and B, C and D, and E and F make pairs, these pairs satisfy the following relationships.

A=/B

C=/D

E=/F

where “/” represents an inverted signal. That is, signal lines A and B, C and D, and E and F are respectively complementary signals.

The three vertical dotted lines in FIG. 1 indicate positions where each signal line is divided into four equal parts. To generate the twisted structure, each signal line is divided into four segments. As shown in FIG. 1, the twisted structure is generated by twisting each pair of complementary signals. The positions of twisting are the positions where each signal line is divided into four equal parts. A twisted structure capable of minimizing the coupling capacitance can also be generated by shifting the twisting positions between adjacent pairs.

In the example shown in FIG. 1, signal line A is connected to a pin P1 of block BLK1 and a pin P2 of block BLK2. Signal line B is connected to a pin P2 of block BLK1 and a pin P1 of block BLK2. Signal line C is connected to a pin P3 of block BLK1 and a pin P3 of block BLK2. Signal line D is connected to a pin P4 of block BLK1 and a pin P4 of block BLK2. Signal line E is connected to a pin PS of block BLK1 and a pin PG of block BLK2. Signal line F is connected to a pin P6 of block BLK1 and a pin PS of block BLK2.

The effect of reducing the coupling capacitance will be explained below with reference to FIG. 2. FIG. 2 specifically shows the six signal lines A to F shown in FIG. 1. Numbers (1) to (4) in FIG. 1 each indicate the ¼ segment of each signal line. For example, a segment corresponding to portion (1) of signal line A is represented by A@(1). Assuming that signal A goes low (signal B goes high), signal C goes high (signal D goes low), and signal E goes high (signal F goes low), FIG. 2 shows these changes by arrows. Each upward arrow indicates the change to high, and each downward arrow indicates the change to low.

For example, signal lines having influences on the coupling capacitance of signal line C are A, B, E, and F. The coupling capacitances of segments C@(1) and C@(4) respectively suffer influences from segments B@(1) and A@(4). Since segment B@(1) is high and segment A@(4) is low, the influences on the coupling capacitances of segments C@(1) and C@(4) are canceled.

The coupling capacitances of segments C@(2) and C@(3) respectively suffer influences from segments E@(2) and F@(3). Since segment E@(2) is high and segment F@(3) is low, the influences on the coupling capacitances of segments C@(2) and C@(3) are canceled. The twisted structure shown in FIG. 1 is an example in which the coupling capacitance reduction effect is maximally achieved because the six signal lines A to F have the same length.

An example of a semiconductor integrated circuit having signal lines different in length will now be explained. FIG. 3 is a view showing the layout of the major components of another example of the semiconductor integrated circuit.

Blocks BLK1 and BLK2 are connected by six signal lines A to F. Assuming that signal lines A and B, C and D, and E and F make pairs, these signal lines satisfy the following relationships.

A=/B

C=/D

E=/F

Signal lines A and B are shorter than signal lines C to F. In this arrangement, positions where the short signal lines A and B are divided into four equal parts are set as the positions of twisting as indicated by the three vertical dotted lines in FIG. 3. A twisted structure capable of minimizing the coupling capacitance can be formed by shifting the twisting positions between adjacent pairs.

The connections between signal lines A to F and pins P are the same as those shown in FIG. 1. Note that signal lines A and B are short in the arrangement shown in FIG. 3, so the effect of reducing the coupling capacitance of signal line C adjacent to segments B@(1) and A@(4) is smaller than that of FIG. 1.

### [2. Layout Design of Semiconductor Integrated Circuit]

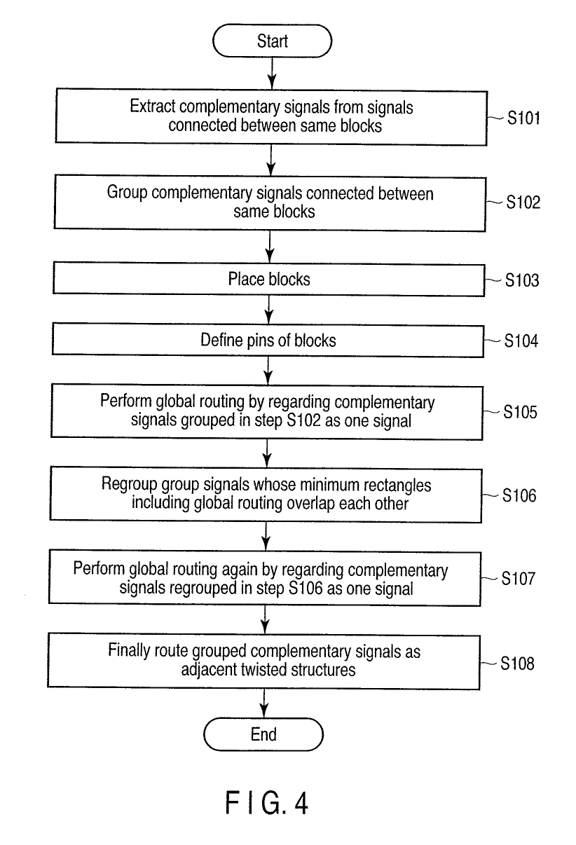

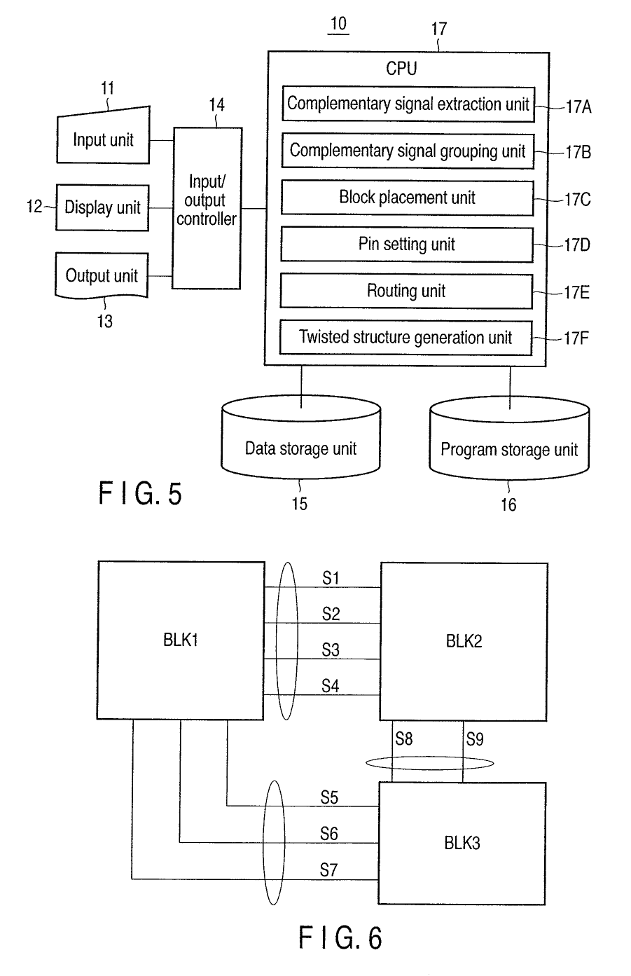

Layout design of a semiconductor integrated circuit including signal lines having the twisted structure will be explained below. FIG. 4 is a flowchart showing a method of designing the layout of the semiconductor integrated circuit including the signal lines having the twisted structure. FIG. 5 is a block diagram showing the arrangement of a design apparatus 10 for designing the layout of the semiconductor integrated circuit including the signal lines having the twisted structure.

The design apparatus 10 includes an input unit 11, display unit 12, output unit 13, input/output controller 14, data storage unit 15, program storage unit 16, and central processing unit (CPU) 17.

The input unit 11 is used by a user to input data, and includes a keyboard or the like. The display unit 12 is used to display the results of processing performed by the CPU 17 to the user, and includes a display or the like. The output unit 13 outputs the results of processing performed by the CPU 17 as data or paper media, and includes a printer or the like. The input/output controller 14 interfaces the CPU 17 with the input unit 11, display unit 12, and output unit 13.

The program storage unit 16 is a computer-readable storage medium storing a program for achieving layout design of this embodiment. The CPU 17 can perform desired layout design by executing arithmetic processing on the basis of the program stored in the program storage unit 16. The data storage unit 15 stores data generated during layout design, and data input by the user.

The CPU 17 controls the overall operation of the design apparatus 10. The CPU 17 includes a complementary signal extraction unit 17A, complementary signal grouping unit 17B, block placement unit 17C, pin setting unit 17D, routing unit 17E, and twisted structure generation unit 17F. The operations of these units of the CPU 17 will be described later.

The method of designing the layout of the semiconductor integrated circuit including the signal lines having the twisted structure will be explained below with reference to the accompanying drawing.

First, in step S101, the complementary signal extraction unit 17A extracts pairs of complementary signals from signals connected between the same blocks BLK. That is, the complementary signal extraction unit 17A generates assertions for checking complementarity to all combinations of signals connected between two blocks BLK. The complementary signal extraction unit 17A executes this assertion generation process on all combinations of two blocks BLK. Subsequently, the complementary signal extraction unit 17A executes assertion check on the generated assertions, and extracts pairs of complementary signals.

This complementary signal extraction process will be explained below with reference to FIG. 6. Referring to FIG. 6, three blocks BLK1 to BLK3 are placed. Signals S1, S2, S3, and S4 exist as signals connected between blocks BLK1 and BLK2. Signals S5, S6, and S7 exist as signals connected between blocks BLK1 and BLK3. Signals S8 and S9 exist as signals connected between blocks BLK2 and BLK3.

Six combinations (S1, S2), (S1, S3), (S1, S4), (S2, S3), (S2, S4), and (S3, S4) exist as combinations of signals connected between blocks BLK1 and BLK2.

Three combinations (S5, S6), (S5, S7), and (S6, S7) exist as combinations of signals connected between blocks BLK1 and BLK3.

One combination (S8, S9) exists as a combination of signals connected between blocks BLK2 and BLK3.

The complementary signal extraction unit 17A generates assertions for checking complementarity to a total of ten combinations described above. Complementary signals are extracted by executing assertion check on the generated assertions.

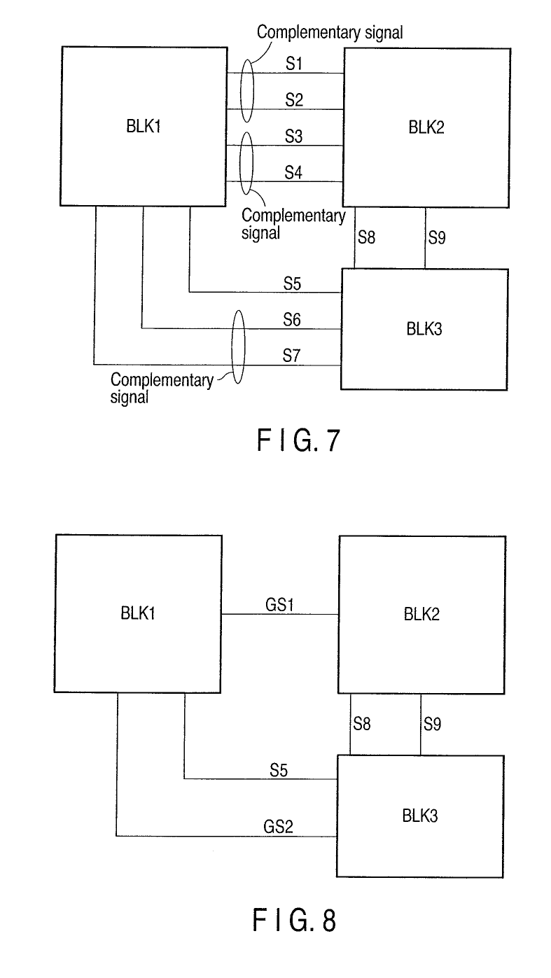

Then, in step S102, the complementary signal grouping unit 17B performs grouping such that complementary signals connected between (across) the same blocks BLK belong to the same group. This grouping process will be explained below with reference to FIGS. 7 and 8.

As shown in FIG. 7, assume that the pairs (S1, S2), (S3, S4), and (S6, S7) are complementary signals. Of these three pairs, (S1, S2) and (S3, S4) are connected to the same blocks BLK and hence grouped as one group. That is, as shown in FIG. 8, the complementary signal grouping unit 17B groups (S1, S2) and (S3, S4) as a group signal GS1. Also, the complementary signal grouping unit 17B groups (S6, S7) as a group signal GS2.

Then, in step S103, the blocks BLK are placed on the basis of a predetermined algorithm. For example, the block placement unit 17C places the blocks BLK so as to minimize the chip area and the length of a signal line connected between blocks.

In step S104, the pin setting unit 17D defines pins of each block BLK. For grouped complementary signals, the pin setting unit 17D defines one virtual pin representing all pins corresponding to these complementary signals. This virtual pin representing the group has a size capable of implementing pins equal in number to signals belonging to the group.

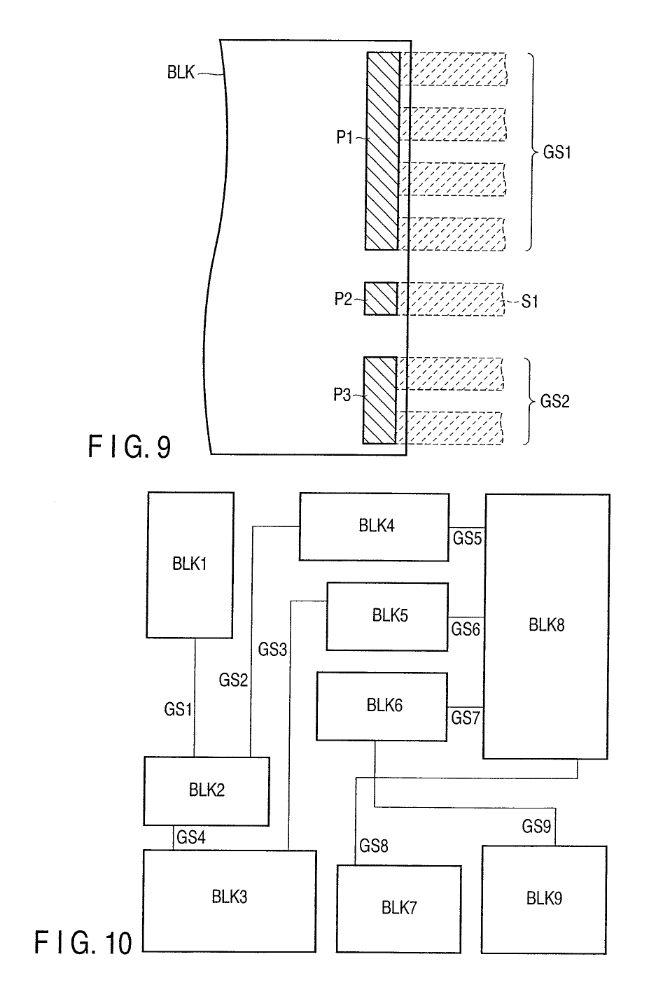

FIG. 9 is a view showing an example of the placement of virtual pins P. Assume that group signal GS1 is obtained by grouping four signals, and group signal GS2 is obtained by grouping two signals. Signal S1 is an ungrouped signal. The pin setting unit 17D places three pins P1 to P3 in the block BLK shown in FIG. 9. Group signal GS1 is connected to pin P1, signal S1 is connected to pin P2, and group signal GS2 is connected to pin P3. Pin P1 of group signal GS1 has a size capable of extracting four signals, and pin P3 of group signal GS2 has a size capable of extracting two signals.

In step S105, the routing unit 17E performs global routing (temporary routing) on the complementary signals (group signals) grouped in step S102, by regarding one group as one signal. This global routing is performed by assuming that routing resources necessary for group signal routing must be equal in number to signals in the group. Note that “global routing” is the process of obtaining rough routing paths. More specifically, a chip (or a routing area) is divided into large grids, and each routing path (which line passes through which grid) is determined on the grid level.

FIG. 10 is a view showing an example of the result of global routing. Blocks BLK1 to BLK9 are placed on a chip (substrate), and grouped complementary signals (group signals GS1 to GS9) are globally routed. Group signal GS1 is routed between blocks BLK1 and BLK2. Group signal GS4 is routed between blocks BLK2 and BLK3. Group signal GS2 is routed between blocks BLK2 and BLK4. Group signal GS3 is routed between blocks BLK3 and BLK5. Group signal GS5 is routed between blocks BLK4 and BLK8. Group signal GS6 is routed between blocks BLK5 and BLK8. Group signal GS7 is routed between blocks BLK6 and BLK8. Group signal GS8 is routed between blocks BLK7 and BLK8. Group signal GS9 is routed between blocks BLK6 and BLK9.

In step S106, the complementary signal grouping unit 17B regroups the group signals GS whose minimum rectangles including global signal routing overlap each other, for the result of global routing obtained in step S105.

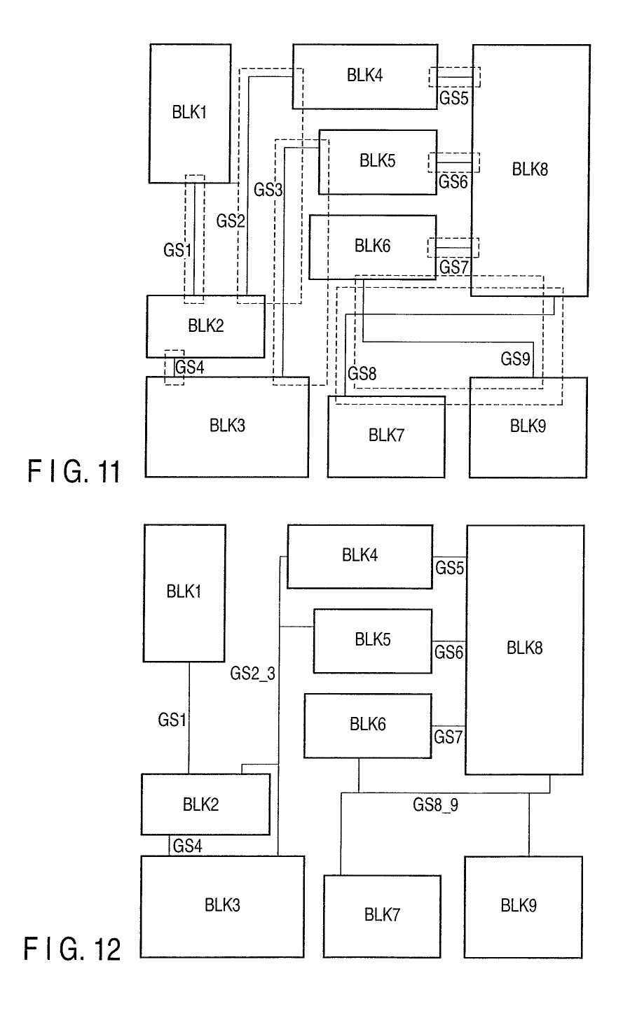

FIG. 11 is a view showing a minimum rectangle (to be referred to as a BBOX (Banding BOX) hereinafter) including global routing of each group signal GS, for the result of global routing shown in FIG. 10. Each rectangle surrounded by the broken lines is the BBOX of the corresponding group signal. In the example shown in FIG. 11, the BBOXs of group signals GS2 and GS3 overlap each other, and the BBOXs of group signals GS8 and GS9 overlap each other. Therefore, the complementary signal grouping unit 17B regroups these group signals.

In step S107, the routing unit 17E performs global routing again on the complementary signals (group signals) regrouped in step S106, by regarding one group as one signal. As in step S105, this global routing is performed by assuming that routing resources necessary for group signal routing must be equal in number to signals in the group.

FIG. 12 is a view showing the result of global routing of the group signals regrouped in step S106. Group signals GS2 and GS3 are globally routed as one group signal GS2_3, and group signals GS8 and GS9 are globally routed as one group signal GS8_9. Note that although not shown in FIG. 12, ungrouped signals (uncomplimentary signals) S are also globally routed in the second global routing step.

In step S108, final routing (detail routing or actual routing) is performed to give the grouped complementary signals the twisted structure. The ungrouped signals S are also finally routed in step S108. The twisted structure routing method is as shown in FIGS. 1 to 3. Note that “final routing” is the process of finally routing signals for each routing channel. For example, routing paths are obtained by using grids formed by subdividing the grids used in global routing. The routing unit 17E and twisted structure generation unit 17F execute this final routing.

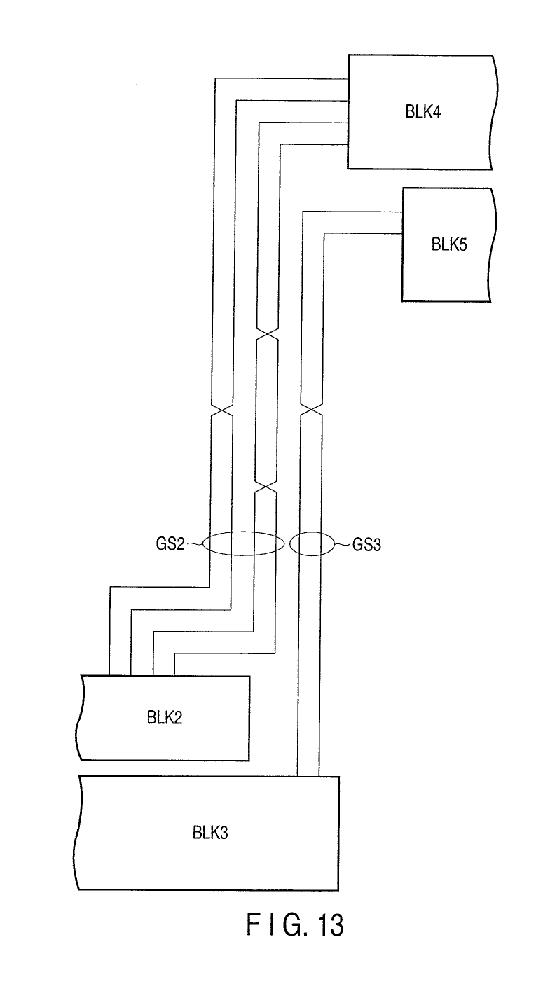

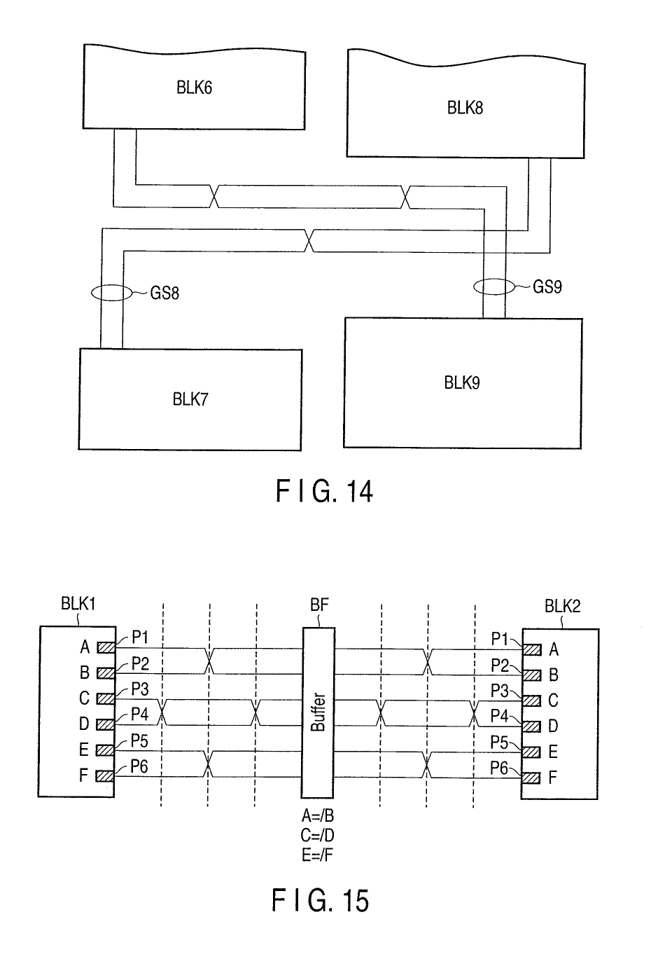

FIG. 13 shows an example in which group signal GS2_3 is implemented as the twisted structure. FIG. 14 shows an example in which group signal GS8_9 is implemented as the twisted structure. Referring to FIGS. 13 and 14, group signal GS2 is regarded as a group having two pairs of complementary signals, and group signals GS3, GS8, and GS9 are each regarded as a group having one pair of complementary signals. Group signals GS2 and GS3 or group signals GS8 and GS9 placed in separated positions in the stage shown in FIG. 10 are routed in adjacent positions through steps S106 and S107.

In this embodiment as described in detail above, a plurality of pairs of complementary signals connected to the same blocks are extracted from a plurality of signals connected between a plurality of circuit blocks. Of the plurality of extracted pairs, complementary signals connected to the same blocks BLK are grouped as one group signal. After that, global routing is performed. Furthermore, final routing is performed by placing complementary signals in adjacent positions, and twisting each of the plurality of pairs of the complementary signals.

In this embodiment, therefore, it is possible to place many complementary signals adjacently to each other, and route these complementary signals by giving them the twisted structure. This makes it possible to reduce the coupling capacitance between signal lines, thereby reducing the coupling noise. Also, the operating speed of the circuit can be increased by reducing the coupling capacitance.

In addition, this embodiment can reduce the noise margin of particularly a circuit that operates at high speed. This facilitates signal timing design, and makes it possible to increase the parametric yield.

### Second Embodiment

In the second embodiment, a buffer is inserted between blocks, and signal lines are connected between the blocks via the buffer. In addition, complementary signals between the blocks and buffer are routed by a twisted structure.

FIG. 15 is a view showing the layout of the major components of a semiconductor integrated circuit including signal lines having the twisted structure according to the second embodiment of the present invention. Blocks BLK1 and BLK2 are connected by six signal lines A to F. Assuming that signal lines A and B, C and D, and E and F make pairs, these pairs satisfy the following relationships.

A=/B

C=/D

E=/F

A first segment of signal line A is connected to a pin P1 of block BLK1 and the input of a buffer BF. A second segment of signal line A is connected to the output of the buffer BF and a pin P1 of block BLK2. Likewise, first segments of signal lines B to F are connected to pins P2 to P6 of block BLK1 and the input of the buffer BF. Second segments of signal lines B to F are connected to the output of the buffer BF and pins P2 to P6 of block BLK2. Note that the buffer BF is illustrated as one box in FIG. 15, but the circuit actually includes six buffers corresponding to the six lines A to F, and these six buffers are electrically isolated. Note also that the buffer corresponding to each line electrically connects the right and left segments of the line.

In addition, the first and second segments of each signal line have the same twisted structure as that shown in FIG. 1. This makes it possible to reduce the coupling capacitance even when the length of the signal line increases.

The arrangement shown in FIG. 15 is an example including one buffer BF (i.e., two segments), in which case blocks BLK1 and BLK2 have the same relationship between the pin placement and signal lines. However, the number of buffers to be inserted between signal lines is of course not limited, so a plurality of buffers may also be inserted. When the number of buffers is an even number (the number of segments is an odd number), the pin placement is as shown in FIG. 1. On the other hand, when the number of buffers is an odd number (the number of segments is an even number), the pin placement is as shown in FIG. 15.

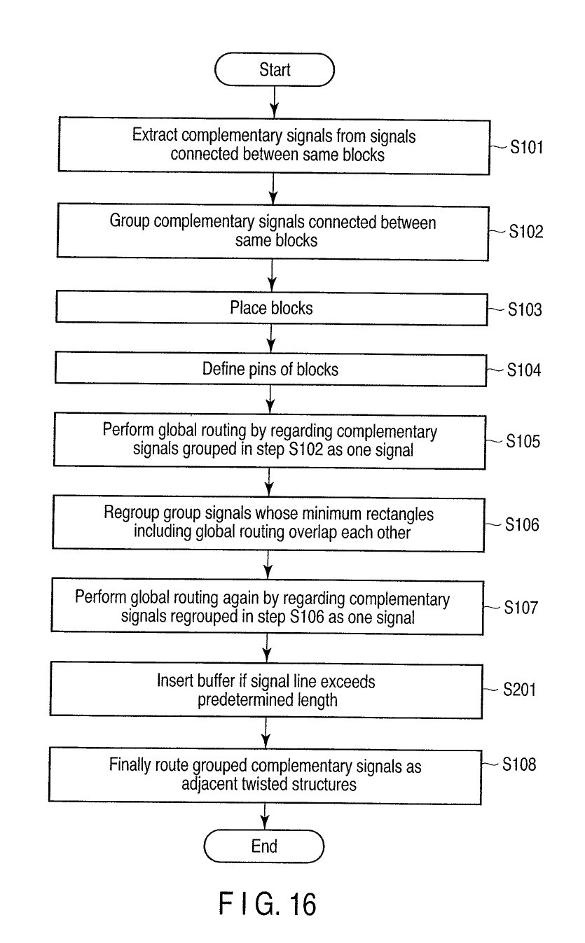

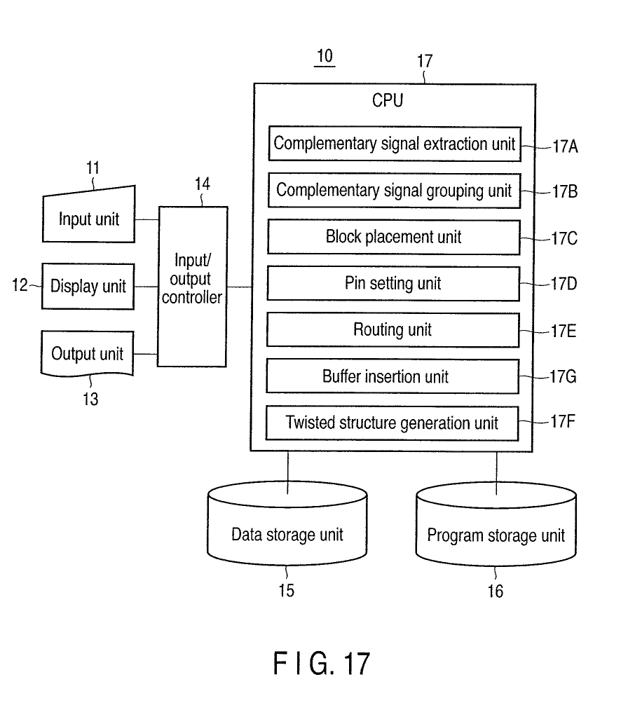

Layout design of the semiconductor integrated circuit including the signal lines having the twisted structure will now be explained. FIG. 16 is a flowchart showing a method of designing the layout of the semiconductor integrated circuit including the signal lines having the twisted structure. FIG. 17 is a block diagram showing the arrangement of a design apparatus 10 for designing the layout of the semiconductor integrated circuit including the signal lines having the twisted structure.

A CPU 17 includes a buffer insertion unit 17G in addition to the arrangement shown in FIG. 5. The operation of the buffer insertion unit 17G will be described later.

The method of designing the layout of the semiconductor integrated circuit including the signal lines having the twisted structure will be explained below with reference to the accompanying drawing. Note that the operation from step S101 to step S107 in FIG. 16 is the same as that of the first embodiment.

Then, in step S201, the buffer insertion unit 17G checks whether a signal line has exceeded a predetermined length. If the signal line has exceeded the predetermined length, the buffer insertion unit 17G inserts the buffer BF midway along the signal line. The number of buffers BF to be inserted increases as the signal line length increases. For example, the number of buffers BF to be inserted is one when the signal line is in the range of the onefold to the twofold of the predetermined length, and two when the signal line is in the range of the twofold to the threefold of the predetermined length.

In step S108, grouped complementary signals are finally routed as the twisted structure. Ungrouped signals S are also finally routed in step S108. Consequently, as shown in FIG. 15, the signal lines connected between the blocks BLK and buffer BF can be given the twisted structure.

In this embodiment as described in detail above, the buffer BF can be inserted midway along a signal line in accordance with its length. In addition, the signal lines connected between the blocks BLK and buffer BF can be given the twisted structure. This makes it possible to reduce the coupling capacitances of the signal lines.

Furthermore, since the buffer BF is inserted midway along a signal line, the wiring delay of the signal line can be reduced. The rest of the effects are the same as those of the first embodiment.

### Third Embodiment

In the first embodiment, the complementary signal extraction step shown in step S101 of FIG. 4 generates assertions for signal combinations for every two blocks BLK. In the third embodiment, however, assertions are generated for all combinations of block signals connected to different blocks, in addition to signals connected to the same blocks.

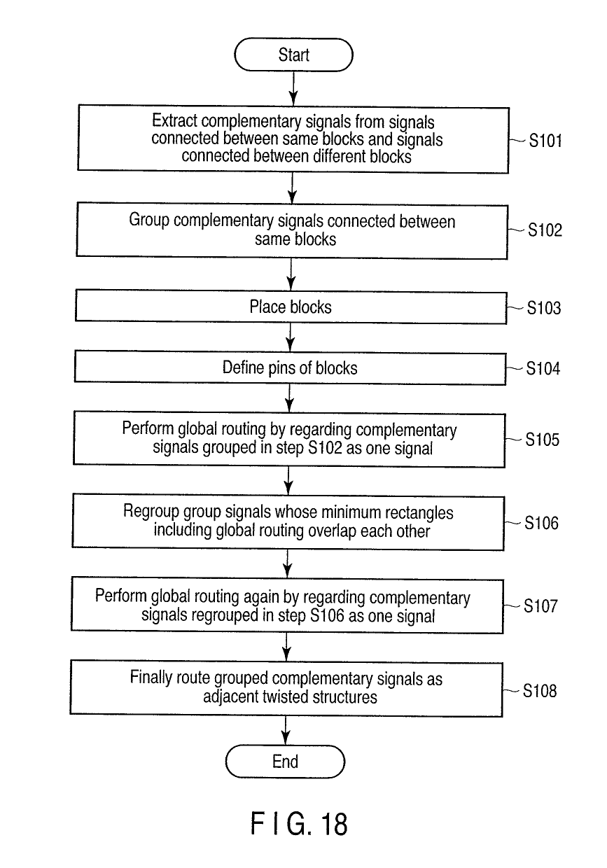

FIG. 18 is a flowchart showing a method of designing the layout of a semiconductor integrated circuit according to the third embodiment of the present invention. In step S101, a complementary signal extraction unit 17A extracts pairs of complementary signals from signals connected to the same blocks BLK and signals connected to different blocks BLK. That is, the complementary signal extraction unit 17A generates assertions for checking complementarity for all combinations of signals connected to all the blocks BLK.

In the example using signals S1 to S9 shown in FIG. 6, the complementary signal extraction unit 17A generates assertions for checking complementarity for 36 signal combinations (S1, S2) to (S8, S9). Thus, while ten assertions are generated in the first embodiment, thirty-six assertions are generated in this embodiment.

Subsequently, complementary signals are extracted by executing assertion check on the generated assertions. In this way, the complementary signal extraction step in step S101 is performed. The subsequent steps are the same as those of the first embodiment.

When the number of assertions to be generated increases, the processing time of assertion check prolongs, but the number of extractable complementary signals also increases. Accordingly, the noise reduction effect can be obtained for more complementary signals than those of the first embodiment. Note that this embodiment is of course applicable to the second embodiment.

### Fourth Embodiment

In the pin setting step shown in step S104 of FIG. 4 in the first embodiment, a virtual pin representing a group has a size capable of implementing pins equal in number to signals belonging to the group. In the same step of the fourth embodiment, however, a virtual pin representing a group has a size capable of implementing pins 1.5 times as many as signals belonging to the group.

The pin setting step in step S104 will be explained below with reference to the accompanying drawing. Note that other steps are the same as those of the first embodiment.

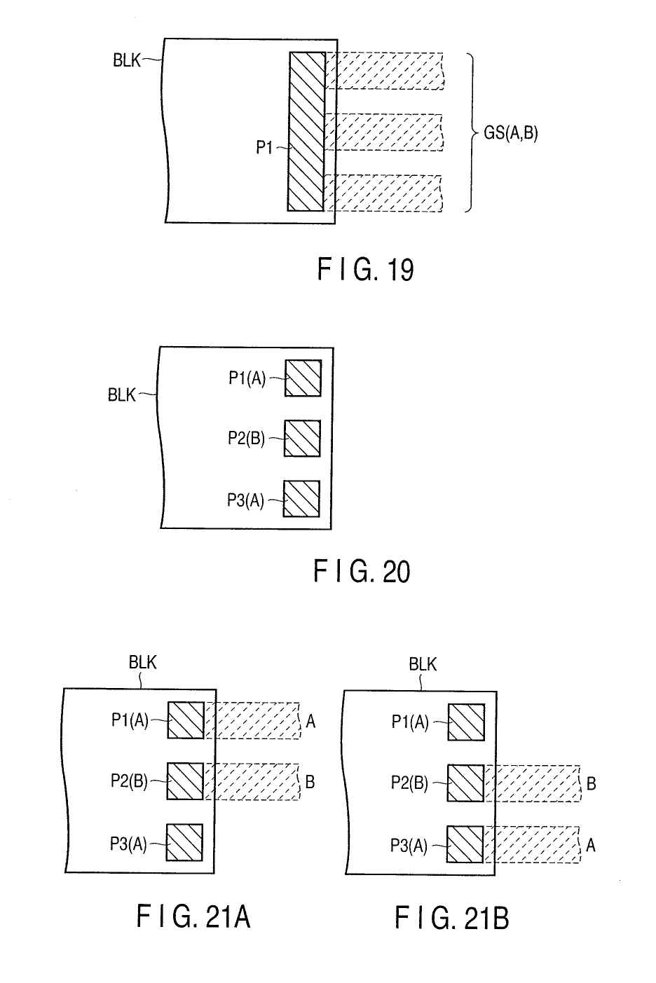

FIG. 19 is a view showing the arrangement of a pin P1 having a size 1.5 times as large as two signals A and B. Assume that a group signal GS connected to a block BLK includes complementary signals of signals A and B. As pin P1 of the block BLK, a pin setting unit 17D defines a pin having a size capable of implementing pins 1.5 times as many as the two signals A and B belonging to the group signal GS. As shown in FIG. 19, pin P1 defined to connect the two signals A and B has a size capable of connecting three signals.

FIG. 20 is a view for explaining the number of pins P to be actually placed. As pins for two signals A and B, a total of three pins, i.e., pins P1(A) and P3(A) connectable to signal A and a pin P2(B) connectable to signal B are placed. Note that it is also possible to set one pin connectable to signal A and two pins connectable to signal B.

By thus placing the pins, it is possible to respectively connect the two signals A and B to pins P1(A) and P2(B) as shown in FIG. 21A, or to pins P3(A) and P2(B) as shown in FIG. 21B.

In this embodiment as described in detail above, it is possible to flexibly control the order of signals when implementing the twisted structure. Even when applying the twisted structure to many complementary signals adjacent to each other, therefore, these complementary signals can be reliably connected to blocks without any problem.

Furthermore, when a buffer BF is inserted midway along complementary signals, signal lines can be connected to corresponding pins even if the order of the signals is changed.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A layout design method comprising:
extracting a plurality of pairs of complementary signals from signal lines connected between a plurality of circuit blocks, for every signal lines connected between the same circuit blocks; and
routing the pairs by twisting each pair.

2. The method of claim 1, further comprising placing the pairs next to each other.

3. The method of claim 1, wherein the pairs comprise a pair of signal lines comprising the same length.

4. The method of claim 1, wherein the pairs comprise a pair of signal lines comprising different lengths.

5. The method of claim 1, further comprising inserting a buffer midway along a signal line,
wherein line segments between the buffer and a circuit block are twisted in the routing.

6. The method of claim 5, wherein a plurality of buffers are inserted in accordance with a length of the signal line in the inserting the buffer.

7. The method of claim 1, further comprising:
placing a pin for connecting a signal line in a circuit block,
wherein an extra pin is placed in order to change placement of one of the twisted signal lines in the placing the pin.

8. A layout design method comprising:
extracting a plurality of pairs of complementary signals from signal lines connected between a plurality of circuit blocks; and
routing the pairs by twisting each pair.

9. The method of claim 8, wherein the pairs comprise a plurality of first pairs of complementary signals connected between the same circuit blocks, and a plurality of second pairs of complementary signals connected between different circuit blocks.

10. The method of claim 8, further comprising placing the pairs next to each other.

11. The method of claim 8, wherein the pairs comprise a pair of signal lines comprising the same length.

12. The method of claim 8, wherein the pairs comprise a pair of signal lines comprising different lengths.

13. The method of claim 8, further comprising inserting a buffer midway along a signal line,
wherein line segments between the buffer and a circuit block are twisted in the routing.

14. The method of claim 13, wherein a plurality of buffers are inserted in accordance with a length of the signal line in the inserting the buffer.

15. The method of claim 8, further comprising:
placing a pin for connecting a signal line in a circuit block,
wherein an extra pin is placed in order to change placement of one of the twisted signal lines in the placing the pin.

16. A computer-readable medium having stored thereon a program executable by a computer, the program controlling the computer to execute functions of:
extracting a plurality of pairs of complementary signals from signal lines connected between a plurality of circuit blocks, for every signal lines connected between the same circuit blocks; and
routing the pairs by twisting each pair.

17. The medium of claim 16, wherein the program further comprises placing the pairs next to each other.

18. The medium of claim 16, wherein the pairs comprise a pair of signal lines comprising different lengths.

19. The medium of claim 16, wherein
the program further comprises inserting a buffer midway along a signal line, and
line segments between the buffer and a circuit block are twisted in the routing.

20. The medium of claim 16, wherein
the program further comprises placing a pin for connecting a signal line in a circuit block, and
an extra pin is placed in order to change placement of one of the twisted signal lines in the placing the pin.
